(19) United States
(12) Patent Application Publication
(10) Pub. No.: US 2013/0092476 A1
(43) Pub. Date: Apr. 18, 2013

(54) VARIABLE DISPLACEMENT LUBRICANT PUMP

(71) Applicants: Stefano Fiorini, Rochester Hills, MI (US); Daniele Righetti, Livorno (IT)

(72) Inventors: Stefano Fiorini, Rochester Hills, MI (US); Daniele Righetti, Livorno (IT)

(73) Assignee: PIERBURG PUMP TECHNOLOGY GMBH, Neuss (DE)

(21) Appl. No.: 13/637,985

(22) PCT Filed: Mar. 30, 2011
(86) PCT No.: PCT/EP2011/054957

§ 371 Date: Dec. 7, 2012

(30) Foreign Application Priority Data
Mar. 31, 2010 (EP) 10158810.1

(51) Int. Cl. F16N 13/00

(52) U.S. Cl. CPC F16N 13/00
USPC 184/26

(57) ABSTRACT

A variable displacement lubricant pump includes a housing, a control ring configured to be shiftable arranged inside the housing, a first control chamber and a second control chamber. The first control chamber and the second control chamber are defined by the housing and by the control ring. A seal comprising a stiff bar and an elastomeric stripe fixed to the stiff bar. The seal is configured to seal the first control chamber and the second control chamber. The stiff bar is configured to slide at the housing. The elastomeric stripe of the seal is attached to the control ring.

### CROSS REFERENCE TO PRIOR APPLICATIONS

This application is a U.S. National Phase application under 35 U.S.C. §371 of International Application No. PCT/EP2011/054957, filed on Mar. 30, 2011 and which claims benefit to European Patent Application No. 10158810.1, filed on Mar. 31, 2010. The International Application was published in English on Oct. 6, 2011 as WO 2011/121045 A2 under PCT Article 21(2).

### FIELD

The present invention relates to a variable displacement lubricant pump for an internal combustion engine. The pump is provided with a housing, a shiftable control ring inside the housing, and a seal sealing a control chamber defined by the housing and the control ring.

### BACKGROUND

A variable displacement lubricant pumps is described, for example, in U.S. Pat. No. 6,375,435 B2. These pumps comprise a housing, a shiftable control ring inside the housing, and a seal which seals a first pressure zone in the control chamber from a second pressure zone. The plastic seal bar is seated in a respective slot and is biased radially towards the control ring by a spring which is positioned in the slot so that the seal is permanently in contact with the outer surface of the control ring. During operation of the pump, the plastic seal is permanently in transversal motion and is in contact with the control ring and the slot wall, so that an abrasion of the seal cannot be avoided which can lead to leakage. The accuracy of the lubricant pressure controlled by the pump consequently decreases. The spring causes also a pre-tensioning of the plastic seal bar, whereby the spring acts at certain points, i.e., the points where the spring is seating. As a consequence, the pretension force distribution is not equal over the length of the plastic seal bar. The assembly of such a pump with a seal which is supported by a spring is also not cost-efficient.

### SUMMARY

An aspect of the present invention is to provide a variable displacement lubricant pump with improved pressure control quality.

In an embodiment, the present invention provides a variable displacement lubricant pump which includes a housing, a control ring configured to be shiftable arranged inside the housing, a first control chamber and a second control chamber. The first control chamber and the second control chamber are defined by the housing and by the control ring. A seal comprising a stiff bar and an elastomeric stripe fixed to the stiff bar. The seal is configured to seal the first control chamber and the second control chamber. The stiff bar is configured to slide at the housing. The elastomeric stripe of the seal is attached to the control ring.

### BRIEF DESCRIPTION OF THE DRAWINGS

The present invention is described in greater detail below on the basis of embodiments and of the drawings in which:

FIG. 1 shows a variable displacement lubricant pump from the plan view; and

FIG. 2 shows a seal, whereby the seal comprise a metal bar and an elastomeric stripe.

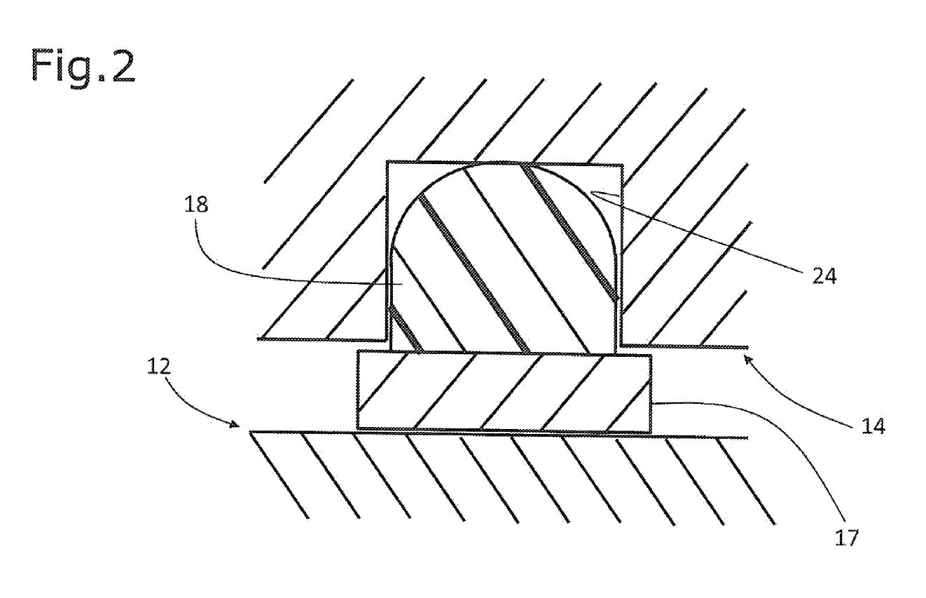

### DETAILED DESCRIPTION

The variable displacement lubricant pump is provided with a housing and a shiftable and basically circular control ring inside the housing. A seal seals a control chamber which is defined by the housing and the control ring. With the control chamber, the position of the control ring is controlled. The control ring pivots at a pivot axis so that the control ring is shifted between a low and a high pump chamber volume position. The seal is provided with a stiff bar and an elastomeric stripe fixed to the stiff bar, whereby the stiff bar slides at an inner surface of the housing, and whereby the elastomeric stripe is attached to the outer surface of the control ring. The inverse arrangement is also forseen, i.e., the stiff bar slides at an outer surface of the control ring, and the elastomeric stripe is attached to the inner surface of the housing.

The elastomeric stripe of the seal provides a radial pre-tensioning of the stiff bar with a homogenous longitudinally force distribution so that the force which pushes the stiff bar against the inner surface of the housing ring is the same at every point of the stiff bar. The pump therefore provides an improved pressure control quality.

In an embodiment of the present invention, the stiff bar can, for example, be a plastic bar, wherein the stiff plastic bar is made out of a thermoplastic elastomer, thermoplastic and/or thermosetting plastic. Plastic materials have many desirable technical properties like hardness, elasticity, heat resistance and chemical resistance, for example, which are adaptable in a broad range.

In an embodiment of the present invention, the stiff bar can, for example, be a metal bar and the metal bar is made out of steel. A contact between the stiff metal bar and the metal housing wall provides a good sealing property. In addition, the abrasion of the stiff metal bar is reduced significantly so that the seal provides good long-term durability. Steel is further an alloy with numerous advantages properties depending on the composition of the steel. The metal bar steel should have an optimal ratio of ductility and stiffness, and good sliding and abrasion properties.

In an embodiment of the present invention, the elastomeric stripe can, for example, be co-molded to the sliding stiff bar. The co-molding of the elastomeric part and the stiff part provides a one-piece seal which is fluid-tight, strong enough to withstand the wear of the relative motion, and which simplifies the mounting procedure.

In an embodiment of the present invention, the elastomeric stripe can, for example, be form-fitted held in a corresponding slot of the control ring (or of the housing). In cross-section, the elastomeric stripe is provided with parallel longitudinal side walls and can, for example, be rectangular. The elastomeric stripe is arranged in a form-fitted slot of the control ring (or of the housing). This embodiment provides a reliable fixation of the elastomeric stripe at the control ring (or at the housing) and simplifies the mounting procedure of the pump because the seal can be mounted to the slot with a single mounting step.

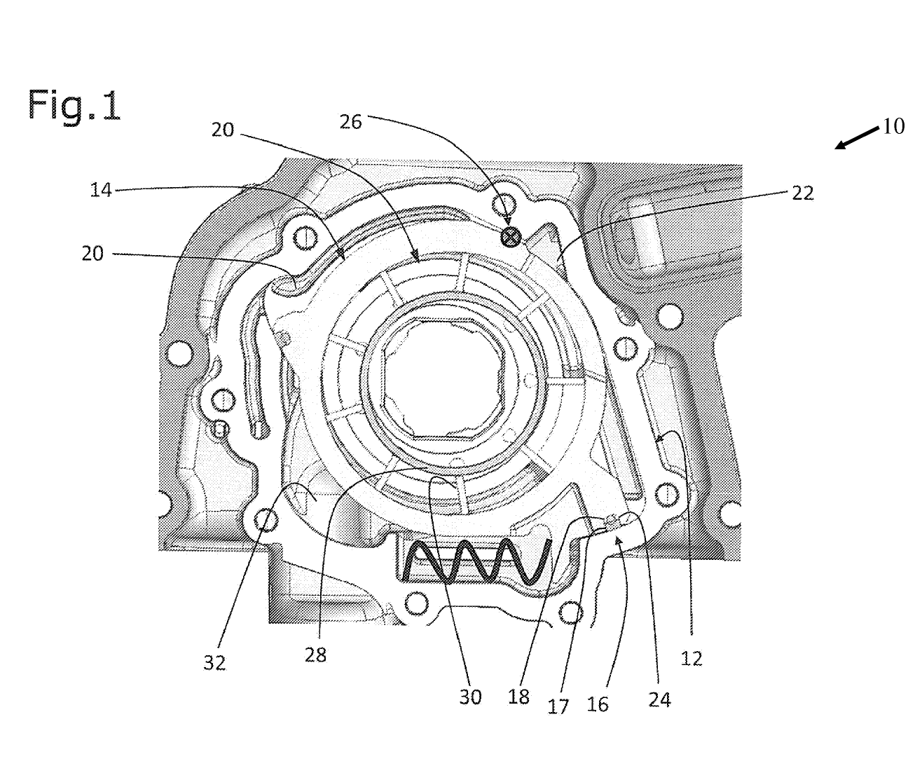

FIG. 1 shows a variable displacement lubricant pump 10 for an internal combustion engine. The variable displacement lubricant pump 10 is for supplying an internal combustion engine with a lubricant, and more particularly, a lubricant with a constant pressure.

The variable displacement lubricant pump 10 comprises a metal housing 12 in which a shiftable control ring 14 is arranged axially between two side walls (not shown). The control ring 14 is provided with a pivot axis 26 at which the control ring 14 pivots, so that the control ring 14 is shifted between a low and a high pump chamber volume position.

The metal housing 12 contains a rotor ring 28 with numerous radially slideable vanes 30, whereby the slidable vanes 30 are rotate inside the shiftable control ring 14. The control ring 14 surrounds a few pump chamber sections separated by the vanes 30. The rotor ring 28 is provided with a protrusion (not shown) which protrudes axially to the outside of one of the side walls. The protrusion of the rotor ring 28 can be rotated by a pump actuator which is not shown.

The variable displacement lubricant pump 10 comprises two control chambers 20, 22 which are formed by the housing 12 and the control ring 14, respectively. The control chambers 20, 22 are opposed to each other with respect to the pivot axis 26 of the control ring 14. Both control chambers 20, 22 provide different pressures with respect to a third chamber 32 under atmospheric pressure. The control chambers 20, 22 are sealed by seals 16 against the third chamber 32. The seals 16 are held form-fitted in respective axial slots 24 of the control ring 14.

The seals 16 comprise a stiff bar 17 and an elastomeric stripe 18 which can, for example, be made out of a lubricant inert plastic. The elastomeric stripe 18 is co-molded to the sliding stiff bar 17. The co-molding can be realized by an adhesive or by any other means and methods known to an expert which lead to a strong and fluid-tight connection. The slots 24 or the seals 16, respectively, are positioned so that the stiff bar 17 of the seal 16 is parallel and vis-à-vis to the pivot axis 26 of the control ring 14. The seal 16 moves on a constant radius with respect to the pivot axis 26 when the control ring 14 is shifted.

With respect to the mounting of the seal, the variable displacement lubricant pump 10 is assembled first by inserting the seals 16 into the corresponding slots 24 of the control ring 14. After that, the control ring 14 is mounted to the housing 12 of the pump 10, thereby compressing the elastomeric stripe 18 of the seal 16.

The present invention is not limited to embodiments described herein; reference should be had to the appended claims.

What is claimed is:

1-7. (canceled)

8. A variable displacement lubricant pump comprising:
a housing;
a control ring configured to be shiftable arranged inside the housing;
a first control chamber and a second control chamber, the first control chamber and the second control chamber being defined by the housing and by the control ring;
a seal comprising a stiff bar and an elastomeric stripe fixed to the stiff bar, the seal being configured to seal the first control chamber and the second control chamber,
wherein,
the stiff bar is configured to slide at the housing, and
the elastomeric stripe of the seal is attached to the control ring.

9. The variable displacement lubricant pump as recited in claim 8, wherein the stiff bar is a plastic bar.

10. The variable displacement lubricant pump as recited in claim 9, wherein the plastic bar is made out of at least one of a thermoplastic elastomer, a thermoplastic, and a thermosetting plastic.

11. The variable displacement lubricant pump as recited in claim 8, wherein the stiff bar is a metal bar.

12. The variable displacement lubricant pump as recited in claim 11, wherein the metal bar is made out of steel.

13. The variable displacement lubricant pump as recited in claim 8, wherein the elastomeric stripe is co-molded to the stiff bar.

14. The variable displacement lubricant pump as recited in claim 8, wherein the control ring or the housing includes a slot, and wherein the elastomeric stripe is form-fitted held in the slot.
